(19) United States
(12) Patent Application Publication
(10) Pub. No.: US 2011/0065451 A1
(43) Pub. Date: Mar. 17, 2011

(54) CONTEXT-TRIGGERED SYSTEMS AND METHODS FOR INFORMATION AND SERVICES

(75) Inventors: José Carlos dos Santos Danado, Montemor-o-Novo (PT); Afonso Miguel Romeiras Lourenco Vàrzea Tavares, Setúbal (PT); Joâo Pedro Gomes da Silva Frazão, Lisboa (PT); Ivan de Almeida Soares Franco, Almada (PT)

(73) Assignee: YDreams-Informatica, S.A., Caparica (PT)

(21) Appl. No.: 12/561,337

(22) Filed: Sep. 17, 2009

(51) Int. Cl. H04W 64/00

(52) U.S. Cl. 455/456.1

(57) ABSTRACT

A computer implemented method for providing location-based services using a mobile device is provided. A location of a mobile device is automatically determined. A user context is generated based at least on a user preference and the automatically determined location of the mobile device, wherein the user preference represents at least a content interest of a user. A request is made to a computer remote from the location of the mobile device for an available service relevant to the user context and compatible with a capability of the mobile device. The available service is executed using the mobile device.

### TECHNICAL FIELD

The present disclosure relates generally to systems and methods relevant to location-based services. Location-based services may be rendered to a user by virtue of, or in reliance on, the location of the user. These services may, for example, be rendered by a mobile device.

### BACKGROUND

At present location-based services (LBS) are typically limited to static content or preprogrammed logic. Current mobile hardware platforms combined with almost ubiquitous network access may enable richer and more dynamic content delivery than is presently available.

### SUMMARY

In accordance with the teachings of the present disclosure, disadvantages and problems associated with existing coordinate-based approaches have been reduced.

In certain embodiments, a computer implemented method for providing location-based services using a mobile device is provided. A location of a mobile device is automatically determined A user context is generated based at least on a user preference and the automatically determined location of the mobile device, wherein the user preference represents at least a content interest of a user. A request is made to a computer remote from the location of the mobile device for an available service relevant to the user context and compatible with a capability of the mobile device. The available service is executed using the mobile device.

In certain embodiments, software embodied in tangible computer-readable media is provided. The software is executable by a central processing unit to automatically determine a location of a mobile device; generate a user context based at least on a user preference and the automatically determined location of the mobile device, wherein the user preference represents at least a content interest of a user; request from a computer remote from the location of the mobile device an available service relevant to the user context and compatible with a capability of the mobile device; and execute the available service using the mobile device.

In certain embodiments, a computing system includes a central processing unit and a memory coupled to the central processing unit. The central processing unit is enabled to automatically determine a location of a mobile device; generate a user context based at least on a user preference and the automatically determined location of the mobile device, wherein the user preference represents at least a content interest of a user; request from a computer remote from the location of the mobile device an available service relevant to the user context and compatible with a capability of the mobile device; and execute the available service using the mobile device.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for determining location information and providing services based on that information, according to an example embodiment of the present disclosure;

FIG. 2 illustrates a view of a mobile device for determining location information, according to an example embodiment of the present disclosure;

FIG. 3 illustrates a system for determining location information, according to an example embodiment of the present disclosure;

FIG. 4 illustrates a data structure (e.g., data relationships) representing various data stored and/or processed by an example embodiment of the present disclosure;

FIG. 5 illustrates a system for providing location-based services, according to an example embodiment of the present disclosure;

FIG. 6 illustrates a data structure (e.g., data relationships) representing various data stored and/or processed by an example embodiment of the present disclosure; and

FIG. 7 illustrates a flowchart of an example method of the present disclosure, according to certain embodiments.

### DETAILED DESCRIPTION

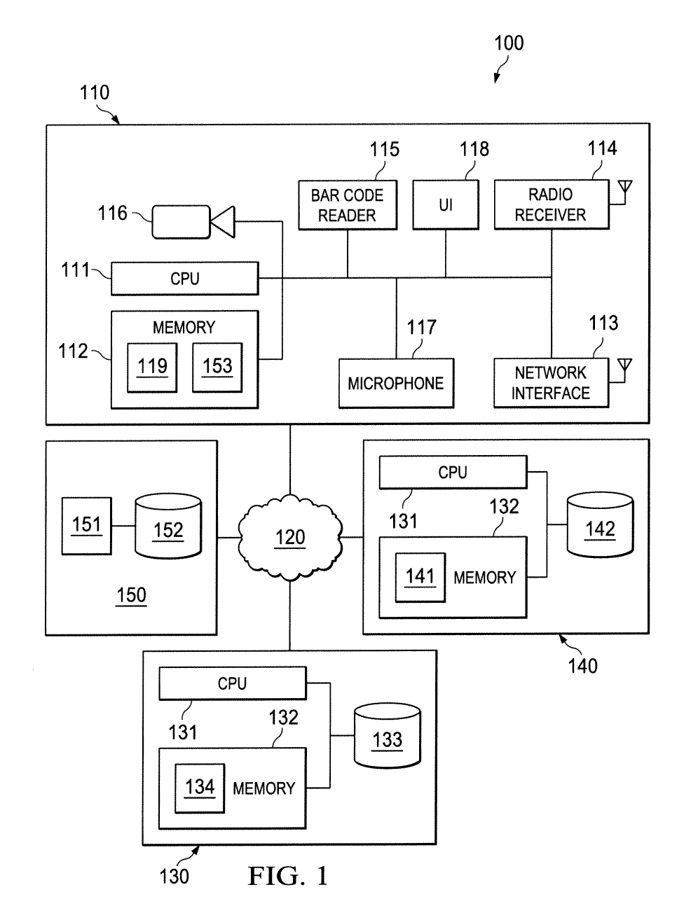

Preferred embodiments and their advantages over the prior art are best understood by reference to FIGS. 1-7 below. However, the present disclosure may be more easily understood in the context of a high-level description of certain embodiments.

The following non-limiting scenario may help the reader understand one or more aspects of the present invention. A user with a mobile device such as a mobile phone is visiting a city. The user is presently at a coffee shop and is interested in shopping for her nephew. The user accesses her mobile device to indicate her interest and determine her present location. The coffee shop is readily identified because a wireless router is broadcasting a unique station identifier: COFFEEJO_WIFI. This location information may be represented as an anchor or as geospatial coordinates. The mobile device may then send this anchor information over a network connection, e.g., a GSM data connection, to a remote computer along with user preference information indicating an interest in shopping for a boy. The remote computer searches through a database of available information services applying the user's context (e.g., location and user preference information).

The search results may include an interactive map for finding nearby playgrounds and arcades, an application for calculating clothing sizes, and an application that works with the video camera on her mobile device to overlay directions to a large toy store over an image of the street in front of the user (e.g., go straight and turn left at the next intersection). The user rejects the interactive map because her nephew isn't with her; and the system updates her user profile accordingly. The user rejects the clothing size calculator because she is interested in a toy or a game for her nephew; and the system updates her user profile accordingly. Finally, the user selects the directions overlay application, and the system updates her user profile accordingly. The application is then downloaded and executed on her mobile device. She follows the directions (narrowly avoiding a light post and two bicyclists) and finds the store. Upon entering the store, the directions overlay application terminates automatically. After purchasing a toy construction set, the user leaves the store and walks by a branch of a large bank. Her mobile device automatically updates its location when it comes within radio range of a wireless router connected to the bank's secure wireless network. (The mobile device cannot access the bank's network, but can read the station identifier as “BIGBANK_LOBBY_{—}003S.”) Her mobile device automatically contacts the remote server with the user's current context and notifies the user of an available application providing a game and advertising a new credit card. The user indicates that she would rather not be disturbed; and the system updates her profile settings accordingly.

Embodiments of the invention of the present disclosure are explained more fully with reference to FIGS. 1-7.

FIG. 1 illustrates a system for determining location information and providing services based on that information, according to an example embodiment of the present disclosure. System 100 may include mobile device 110, network 120, remote computer 130, directory server 140, and remote computer 150. Mobile device 110 may include central processing unit (CPU) 111, memory 112, network interface 113, radio receiver 114, bar code reader 115, camera 116, microphone 117, user interface 118, mobile application 119, and available service 153. Remote computer 130 may include CPU 131, memory 132, database 133, and remote application 134. Directory server 140 may include CPU 131, memory 132, directory 141, and database 142. Remote computer 150 may include remote service 151 and remote service database 152.

System 100 illustrates components useful for implementing a range-centric contextual information system. System 100 may include at least one mobile device 110 connected via network 120 to at least one remote computer 130. Network connectivity via network 120 may be continuous or intermittent. System 100 may be a closed system wherein the mobile devices 110 and remote computers 130 may be operated by a single organization or company. Alternatively, system 100 may be a publicly available service where mobile devices 110 are individually owned and each accesses the at least one remote computer 130.

Mobile device 110 provides a platform for determining a user's location, communicating with remote computer 130, and allowing the user to interact with location-based services. Mobile device 110 may be, for example, a mobile phone, personal digital assistant (PDA), smart phone, netbook, laptop computer, dedicated device, or digital camera. In some embodiments, mobile device 110 is continuously and automatically performing the presently disclosed methods. In other embodiments, the user manually activates one or more of the presently disclosed methods, e.g., by launching mobile application 119. Mobile device 110 may include a number of components as integral components or as peripheral components. These components are identified and described as follows.

Central processing unit (CPU) 111 enables the execution of local software and the interaction of various other components. CPU 111 may be one or more microprocessors or microcontrollers capable of executing programmed software instructions. CPU 111 may be, for example, an ARM-based processor, a MIPS-based processor, or an X86 compatible processor. CPU 111 may be a low-power, embedded processor or microcontroller.

Memory 112 stores software instructions and data for use by CPU 111 and/or other components of mobile device 110. For example, as shown in FIG. 1, memory 112 may store mobile application 119 and available service 153. Memory 112 may be one or more of the following types of tangible computer-readable media, e.g., RAM, ROM, EPROM, flash memory, magnetic storage, or optical storage. Memory 112 may also include a combination of memory types. Memory 112 may be volatile, non-volatile, or include both volatile and non-volatile technologies.

Network interface 113 provides connectivity, via network 120, to remote computer 130. Network interface 113 may be, for example, Ethernet, WiFi, WiMax, GSM, CDPD, Bluetooth, wireless USB, short message service, or a two-way pager. Network interface 113 may be a wired or wireless connection and may be continuously available or intermittent.

Radio receiver 114 provides reception of data from a radio frequency transmitter in order to capture a transmitter identifier for that transmitter, which may provide location identifying information. Radio receiver 114 may be, for example, a cell phone interface, an RFID reader, or any of the wireless networking technologies listed with reference to network interface 113. Further, radio receiver 114 may not be necessary if network interface 113 supports one or more wireless protocols and can provide this information to mobile device 110. In some embodiments, radio receiver 114 may receive and identify another mobile device within radio transmission range, e.g., another user's cell phone SIM information.

Bar code reader 115 allows mobile device 110 to read one and/or two-dimensional barcodes, which may provide location identifying information. Bar code reader 115 may include a scanning light source and receiver. Bar code reader 115 may read location identifying information directly from the bar code, e.g., if a museum includes a barcode encoding “Museum of Fine Art, South Entrance” or “Dinosaur Exhibit.” In some embodiments, the information read from the barcode may be used by mobile device 110 to look up additional identifying information from a database (e.g., database 133 or an external database). For example, an arborist may have affixed a barcode to a historic or prominent tree with a numeric identifier. This identifier may identify the location, but additional information may be available on the arborist's website which may include a plain language description or name for the tree, e.g., “Treaty Oak” or “Bald Cypress on North lawn of the Capital.”

Camera 116 allows mobile device 110 to capture still images or video at the user's location, which may provide location identifying information. Camera 116 may be an integral camera element, e.g., embedded in a camera phone or smart phone, or may be a peripheral device connected to mobile device 110. Camera 116 may have sufficient resolution, image quality, and light sensitivity to allow identification of location identifying characteristics of the subject of the photograph. For example, in some embodiments, camera 116 may be a low resolution, black and white camera, designed to read letters, numbers, bar code labels, and Braille. In these embodiments, camera 116 provides an easy mechanism for data entry (rather than having the user key in the information) especially where the user cannot read the printed language sufficiently well to be able to key in the information (e.g., a Westerner attempting to identify a sign written in Sanskrit, Greek, or Kanji). In other embodiments, camera 116 may be a high-resolution, color camera, capable of taking a clear picture of a building or natural formation. The captured image may be sufficiently detailed and clear to allow image recognition to identify the subject of the photograph in order to identify the user's location. Camera 116 may provide further information such as the field of view, depth of view or calculated range to subject for more accurately determining the user's location.

Microphone 117 allows mobile device 110 to capture audio from the user's location, which may provide location identifying information. Microphone 117 may be an integral element, e.g., the microphone in a mobile phone handset, or a peripheral device connected to mobile device 110. Microphone 117 may capture monaural or stereophonic sound. In some embodiments, microphone 117 may be combined with a speech recognition unit to recognize announcements made in mass transit vehicles, government buildings, and museums. Thus microphone 117 may capture an announcement of “Palais Royal” or “Aldwych” that may be interpreted by CPU 111 to identify a train station in Paris or London, respectively. In some embodiments, microphone 117 may record background or ambient sounds to attempt to match characteristic sounds to known locations. For example, a bell on an old church may have a distinctive ring, or the sound of elevated trains at one intersection in Chicago may have a distinctive screech.

User interface 118 allows the user to interact with mobile device 110, especially to confirm the identity of a location, select one or more anchors or to give a descriptive name of a place. User interface 118 may be a standard mobile phone interface with a small liquid crystal display (LCD) and a set of buttons. User interface 118 may incorporate a touch screen over an LCD. User interface 118 may rely on a speaker and microphone, especially where a compact size is critical or where a user may not have sufficiently good eyesight to read an LCD or sufficiently good dexterity to type characters into the mobile device. In some embodiments, the user interface may identify a location but the identity is not in a human friendly format. For example, mobile device 110 may use camera 116 to identify a statue such that another mobile device 110 taking a picture from nearly the same place will match the same internal identifier. However, user interface 118 may prompt the user to enter (e.g., by typing text characters or speaking) a human friendly name such as “Venus Di Milo.” In some embodiments, user interface 118 may prompt the user to enter a name in the user's native language if only foreign language names have been previously entered by other users.

Mobile application 119 enables the location identification of mobile device 110 and generates an anchor (described more fully in reference to FIG. 4 below) from at least the identified location. Mobile application 119 may be, for example, an operating system extension, a browser plug-in, application software, firmware, object code, or a script. In some embodiments, mobile application 119 may be programmed to identify a location-identifying physical characteristic (LIPC). In some embodiments, a single LIPC may be available to mobile device 110. In other embodiments, multiple LIPCs may be available. In some of those embodiments, mobile application 119 may be programmed to poll each available source of LIPC in priority order seeking a single, optimal LIPC. In other embodiments, mobile application 119 may be programmed to identify all available LIPCs, or all available LIPCs satisfying some criteria. For example, if the LIPC source is radio receiver 114, mobile application 119 may reject an LIPC with a radio signal strength below a predetermined minimum threshold.

Available service 153 enables active and/or interactive presentation of content, e.g., provided by a third-party advertiser or software developer. Available service 153 may be, for example, a browser plug-in, application software, object code, or a script. In some embodiments, available service 153 may be one of a plurality of applications present on mobile device 110 and activated only when appropriate, as determined based upon the current location of mobile device 110 and a user profile. In some embodiments, available service 153 may be downloaded from a remote server for local execution. In certain embodiments, available service 153 may be bundled with content. In some embodiments, available service 153 may request content from one or more remote computers 130. Further, mobile device 110 may cache downloaded available service 153 for execution at a later time. This cache, e.g., in memory 112, may allow mobile application 119 to launch available service 153 when an appropriate location has been identified even if network 120 is unavailable. For example, if available service 153 directs a user to nearby coffee shops, which are affiliated with the service, mobile application 119, upon determining that an affiliated coffee shop is proximate to mobile device 110, may launch available service 153 from the cache. In some embodiments, this cache function is valuable when users return to a recently visited location and remain interested in available service 153.

In some embodiments, available service 153 may request content from an internet search engine. For example, suppose the user is in the Dallas Cowboy's stadium and decides to pick up flowers for a friend. Mobile device 110 senses a wireless access point named “DALLAS_COWBOYS” and forms an anchor representing this stadium. Mobile device 110 activates available service 153 named “Instant Flower.” Because the stadium is new, the service has no record (in remote service database 153 or service content 503) of a flower shop in the vicinity of the stadium. As a result of the empty query result set, Instant Flower service 153 automatically queries one or more internet search engines. Instant Flower service 153 discovers a blog entry explaining how the writer bought flowers after touring the stadium as part of a pre-opening press event. Instant Flower service 153 presents this information to the user.

Network 120 enables bi-directional communication between mobile device 110 and remote computer 130. Network 120 may be, for example, a GSM network, a cellular network with CDPD service, a WiFi or WiMax internet connection, or a two-way pager network. Network 120 may be a public network or a private network. Network 120 may be a peer-to-peer connection or an ad-hoc network.

Remote computer 130 provides an aggregation of anchor data for access by one or more mobile devices 110. Remote computer 130 may also allow additional remote computers or remote services to query anchor's database 133. Remote computer 130 may be, for example, a personal computer, a server, a virtual computer in a cloud computing environment, or multiple computers of any type. Remote computer 130 may be running an operating system capable of supporting server software such as a web server or other IP based services.

Central processing unit (CPU) 131 enables the execution of local software and the interaction of various other components. CPU 131 may be one or more microprocessors or microcontrollers capable of executing programmed software instructions. CPU 131 may be, for example, an ARM-based processor, a MIPS-based processor, an X86 compatible processor, or a RISC processor. CPU 131 may be a high performance model of a processor family to handle simultaneous communications with many mobile devices 110.

Memory 132 stores software instructions and data for use by CPU 131 and/or other components of mobile device 110. Memory 132 may be one or more of the following types of tangible computer media, e.g., RAM, ROM, EPROM, flash memory, magnetic storage, or optical storage. Memory 132 may also include a combination of memory types. Memory 132 may be volatile, non-volatile, or include both volatile and non-volatile technologies.

Database 133 stores an aggregation of anchor data for access by one or more mobile devices 110, additional remote computers or additional remote services. Database 133 may be, for example, a commercial database, a flat file, or a data-structure stored in RAM. In some embodiments, long-term persistence may be a critical requirement, for example, where a large, continuously growing database is desired. In one such example, a new wireless network infrastructure is being installed, thus emphasis is put on adding new anchors to the system. In some embodiments, short-term storage will suffice, for example, where transient movements or behaviors are being analyzed. In one such example, a service may be marketed as a crowd monitor to help people find or avoid large gatherings, thus deemphasizing old or stale data.

Remote application 134 enables the aggregation and retrieval of anchors generated by one or more mobile device 110 and retrieval by additional remote computers or remote services. Remote application 134 may be, for example, a web server, a service providing a connection-based protocol, or a service providing a light-weight, transaction-based protocol. Remote application 134 may perform a data aggregation function by accepting an anchor generated at mobile device 110 and transmitted to remote computer 130 via network 120. In some embodiments, when remote application 134 receives an anchor from mobile device 110, remote application 134 creates a new record in the database based at least in part on the received anchor data. Further processing of the new record may be unnecessary unless and until a subsequent database query retrieves that record.

In some embodiments, remote application 134 will process an incoming anchor received from mobile device 110 as follows. Remote application 134 will query database 133 for a matching anchor record, e.g., one which is associated with the same LIPC and therefore represents the same physical and/or logical location. If a matching anchor record is not found, a new anchor record may be created in database 133 based at least in part on the received anchor. Otherwise, the matching record in database 133 may be updated and/or augmented with information from the received anchor. In some embodiments, the matching record in database 133 is augmented with a user identifier and/or a timestamp indicating when the user was recorded to be at that location by mobile device 110. In some embodiments, remote application 134 may, upon receipt of an anchor from a mobile device 110, store anchor information in database 133 along with chronotope information, which is described more fully in reference to FIG. 4.

In addition to aggregation of anchor and/or chronotope information, remote application 134 may also receive and process queries submitted by mobile devices 110, or additional remote computers or additional services, via network 120. In some embodiments, a user may submit a query by interacting with user interface 118 as follows. A user selects one or more anchors in her vicinity, which may have been previously determined by mobile application 119 based on one or more LIPCs, and requests the remote computer to activate a remote service. In some embodiments, mobile application 119 may have communicated with remote application 134 to retrieve a user-friendly location description from database 133. If a user-friendly location description was retrieved, mobile application 119 may simply present this description to the user for approval or objection. After user selection of one or more anchors, a query may also be entered with one or more query parameters, e.g., “nearby pizza restaurants” or “least visited clothing stores.” Mobile application 119 may then transmit the list of anchors jointly with the one or more query parameters to remote application 134 via network 120. Remote application 134 receives the query and searches for related remote services 151, e.g., “pizza restaurants directory,” in database 133 based on the query parameters and the location of mobile device 110, represented as an anchor.

The query activates a service, e.g., “pizza restaurants directory,” automatically or upon user selection. wherein the user sends a new query based at least on the previous query parameters and the location of mobile device 110 to listed services within database 133, via network 120, and sent to mobile application 119 after successful answer from queried services for UI 118. “Pizza restaurants directory” then queries database 133 to calculate nearby “pizza restaurant” from a list of sent anchors related to “pizza restaurants”. Database 133 sends nearby “pizza restaurant” to “pizza restaurants directory” and, afterwards, “pizza restaurants directory” transmits the search results to mobile application 119 via network 120.

Remote application 134 may support one or more types of queries. Before describing these queries, some defined terms may be useful. The current anchor (CA) is defined as an anchor representing and/or associated with the current location of a mobile device 110. The previous anchor (PA) is defined as an anchor representing and/or associated with last (i.e., most recent) identified location of the same mobile device 110. Thus, if a particular mobile device 110 has been associated, in chronological order, with anchors A1, A2, and A3, anchor A2 is the PA and anchor A3 is the CA.

There may or may not be a limit on the types of queries relevant to location-based services. The present disclosure describes embodiments with a non-limiting set of query types. In one scenario, a user may be hungry for pizza and may want to find a nearby pizza restaurant. In some embodiments, the user may submit a query, e.g., “nearby pizza restaurants,” that is transmitted by mobile application 119 to remote application 134 for processing. In some embodiments, remote application 134 consults a remote service 151, e.g., “pizza restaurants directory,” to receive a list of pizza restaurants for correlation with anchors in database 133. (Remote service 151 is described more fully below.) In some embodiments, remote application 134 relies on the user-friendly names and/or user-generated content to identify pizza restaurants.

Remote application 134 may translate this query into a query suitable for database 133. This query may be decomposed into two queries:
1) find a set of anchors linked to CA by one or more chronotopes wherein each of the set of anchors also corresponds to a location in the list of pizza restaurants (or has “pizza restaurant” in the user-friendly name, if no list is available); and
2) sort the set of anchors by the total distance between each candidate anchor and CA where the total distance is the sum of the distances represented by the one or more chronotopes linking CA with each candidate anchor.

For example, suppose CA is a particular downtown theater. On a prior occasion, one user traveled from CA to a coffee shop in five minutes and then traveled from that coffee shop to Little Italy Pizza in three minutes. On another prior occasion, a second user travelled from CA directly to Leaning Tower Pizza in ten minutes. On yet another prior occasion, the second user travelled from CA to a Joe's Pizza in a town with intermediate stops at a drive-through coffee shop and a gas station with a cumulative travel time of fifty-five minutes. As a result of the query for “nearby pizza restaurants,” remote application 134 might transmit to mobile application 119 the list of “Little Italy Pizza” and “Leaning Tower Pizza,” in that order, with the series of chronotope between CA and Joe's Pizza omitted from the search result as too distant. Remote application 134 may transmit additional information as well including, for example, the route taken and transit times for each leg of the route (represented by chronotopes). Resulting information is received by the remote service 151 (e.g., “pizza restaurants directory”) and sent to mobile application 119.

In another scenario, a user may wish to find a unique shirt to wear to a party. In some embodiments, the user may enter a query, via user interface 118, represented by the phrase: “least visited clothing stores.” Remote application 134 receives the query and searches for related remote services 151, e.g. “clothes stores directory,” in directory 141 based on the query parameters and the location of mobile device 110, represented as an anchor. In some embodiments, the query activates a remote service 151, e.g. “clothes stores directory,” automatically. In some embodiments, a list of available remote services 151 is sent to mobile application 119 and is communicated to the user via UI 118 for manual selection. Once activated, remote service 151 then queries remote application 134 for the least visited of a set of identified clothing stores, each of which is represented by one or more anchors. Remote application 134 receives this query as described above and decomposes the query into: 1) find anchors representing matching sent anchors, and 2) sort the resulting set of anchors by the number of chronotopes connecting each to another anchor.

Directory server 140 provides a directory of services available to mobile device 110 or remote computer 130. Directory server 140 may be, for example, a personal computer, a server, a virtual computer in a cloud computing environment, or multiple computers of any type. Directory server 140 may be running an operating system capable of supporting server software such as a web server or other IP based services. Directory server 140 may include CPU 131, memory 132, directory 141, and database 142. Directory 141 stores information about services e.g., remote service 151, which is described below. This information may include an identifier, a name, a description, descriptive tags, classifiers, and/or real-time or near real-time status information. Directory 141 provides a query capability for identifying and locating services based, for example, on the user's present interest. Directory 141 may be an implementation of the lightweight directory access protocol (LDAP), domain name service (DNS), or a similar technology. Database 142 provides underlying storage for this directory information.

Remote computer 150 provides remote service 151, which may have relevant data in remote service database 152. Remote computer 150 may be configured according to the description of remote computer 130, above, but need not be identically configured. Remote service 151 provides a service or capability accessible by mobile device 110. For example, remote service 151 may provide a directory of clothing stores or pizza restaurants. In another example, remote service 151 may provide information about local tourist attractions. Remote service 151 may require or benefit from access to database 133. Mobile device 110 may access remote service 151 directly (via network 120) or may first access directory 141 to identify and locate remote service 151.

In one example embodiment, a user query for nearby pizza restaurants may be sent from mobile application 119 to remote application 134. Remote application 134 may forward the query, in whole or in part, to directory 141 and request an applicable remote service 151. Remote service 151, e.g., “pizza restaurants directory,” may then execute the query against database 133 in conjunction with a list of pizza restaurants in remote service database 152.

The illustration of remote computer 130, directory server 140, and remote computer 150 as separate computers coupled via network 120, however these functions could all be performed on the same computer or could be distributed in alternative arrangements.

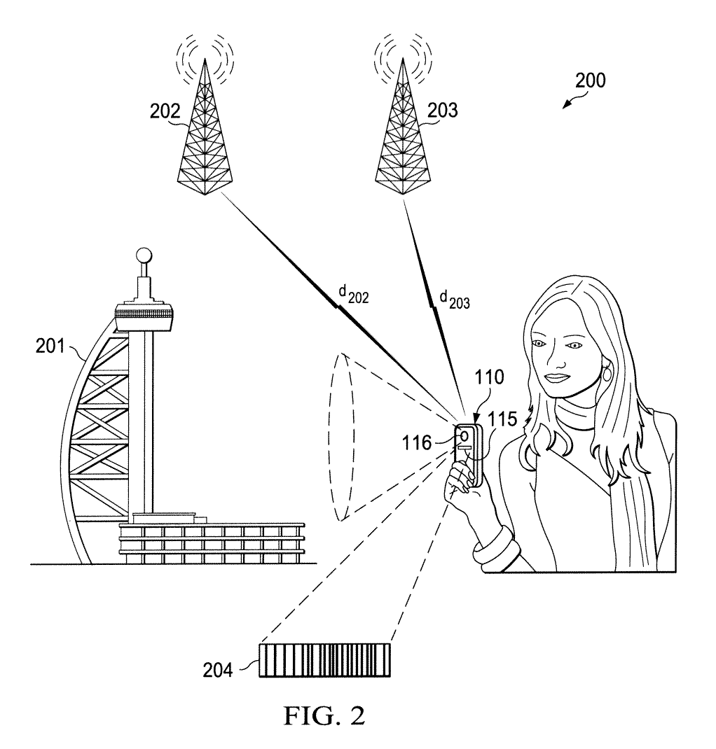

FIG. 2 illustrates a view of a mobile device for determining location information, according to an example embodiment of the present disclosure. View 200 illustrates a user at a particular location holding mobile device 110. Mobile device 110 is within radio reception of radio transmitters 202 and 203 located distances d₂₀₂ and d₂₀₃ away from mobile device 110, respectively. Camera 116 may be capable of capturing an image of landmark 201. Further, barcode reader 115 may be capable of reading bar code 204, which may be affixed to a sign or other object in the scene.

In some embodiments, mobile device 110 includes camera 116, which may be used to capture an image and/or video of landmark 201. In some embodiments, mobile application 119 may incorporate image recognition software capable of identifying features of the subject of a photograph and capable of generating a representative code that can be matched against a previously generated representative code. In other embodiments, mobile application 119 may transmit captured image and/or video data to remote computer 130 where remote application 134 may perform the image recognition function. In these embodiments, the representative code may be used as an LIPC or may be used to lookup or generate an LIPC.

In some embodiments, mobile device 110 includes bar code reader 115, which may be used to read bar code 204 affixed to a sign or object in the scene. Bar code 204 may have been affixed to the sign or object for the purpose of identifying the location, or this use may be incidental to the original purpose of the bar code. For example, bar code 204 may be affixed to an ATM machine in a store and may represent the serial number of the ATM. Mobile application 119 may use the serial number as an LIPC to uniquely identify the store or an area within the store that is in close proximity to the ATM, at least as long as the ATM remains in place.

In some embodiments, mobile device 110 includes radio receiver 114. In view 200, mobile device 110 is within radio reception range of transmitters 202 and 203 located distances d₂₀₂ and d₂₀₃ away from mobile device 110, respectively. Transmitters 202 and 203 may be any type of radio transmitter in proximity to mobile device 110 and may broadcast a unique transmitter identifier. Distances d₂₀₂ and d₂₀₃ may be used to determine which transmitter may be the best proxy for physical distance. Mobile application 119 may compare the relative distances to choose the transmitter identifier of the transmitter (e.g., 202, 203) closest to mobile device 110 as the LIPC. Distances d₂₀₂ and d₂₀₃ may be proxies for or rough estimates of physical distances. In some situation, where transmitters 202 and 203 are of the same basic technology, mobile application 119 may simply compare the raw signal strength and use the transmitter identifier of the transmitter with the stronger signal as it may be closer.

In some situations, especially where transmitters 202 and 203 are of different basic technologies, mobile application 119 may compare the strength of a signal from transmitters 202 and 203, for example, against a range of possible signal strengths determined, at least in part, on the transmission technology. The results of this comparison may be used to normalize the signal strengths for a more useful comparison of d₂₀₂ and d₂₀₃. An example process for normalization is as follows. Suppose transmitter 202 is a WiFi router with a known effective range of roughly 300 feet, mobile application 119 may calculate an estimated, though likely inaccurate, distance d₂₀₂ in feet based on a sensed signal strength compared to a minimum and maximum possible signal strength (determined mathematically or through field testing) and an inverse quadratic relationship between distance and signal strength. If transmitter 203 is a GSM tower in a hilly region, the GSM tower range may be a mile and a half. This information, combined with some sampled data or mathematical models, may be used by mobile application 119 to estimate a normalized d₂₀₃.

In some embodiments, mobile application 119 may first sort the available wireless signals by range, from shortest range to longest range, and select the strongest signal available from the shortest range transmitters within effective transmission range of mobile device 110. This may provide the most localized LIPC. Further, such an embodiment would be able to use longer range transmitters, e.g., FM broadcast transmitters or GSM satellite transmitters, where no other LIPCs are available. Users in certain areas, including those on ships at sea or travelling across stretches of sparsely populated countryside, may benefit from this approach.

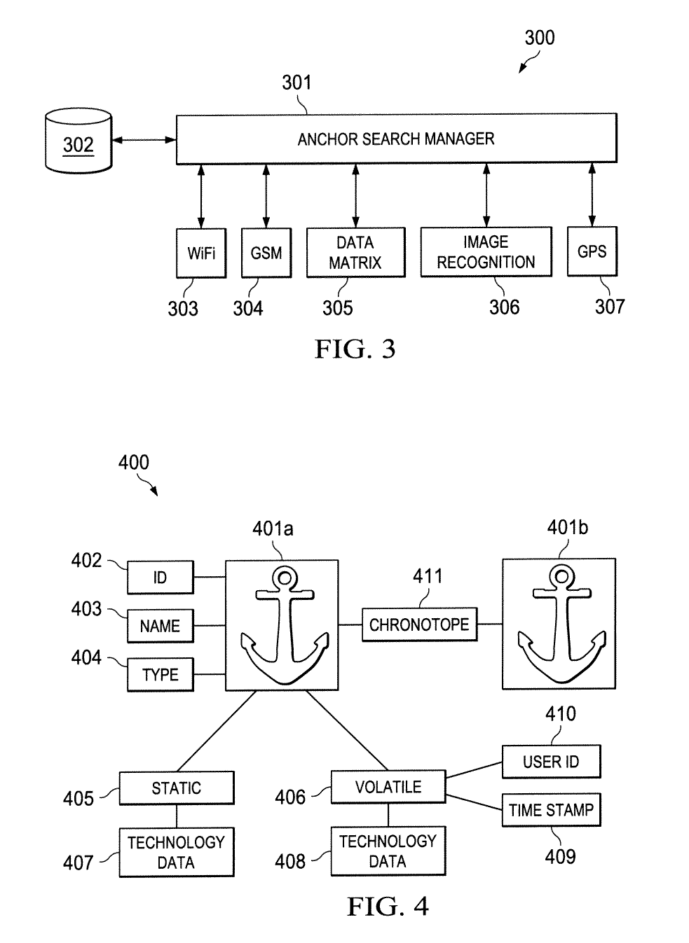

FIG. 3 illustrates a system for determining location information, according to an example embodiment of the present disclosure. System 300 for determining location information may include anchor search manager 301, database 302, and one or more LIPC identification modules including WiFi search 303, GSM search 304, data matrix scan 305, image recognition 306, and GPS 307.

System 300 illustrates components for identifying one or more anchors that identify the current location of mobile device 110. In some embodiments, some or all of the components illustrated in system 300 may be incorporated into mobile device 110. In other embodiments, some of the components illustrated in system 300 may be incorporated into remote computer 130. For example, database 302 may be incorporated into mobile device 110 in some embodiments, into remote computer 130 in other embodiments, and into each of mobile device 110 and remote computer 130 in other embodiments. The logical arrangement of the various modules is for illustration purposes only. One of ordinary skill in the art would understand that functionally may be completely integrated or modularized in a variety of different ways without deviating from the goals of the present disclosure.

Anchor search manager 301 is a processing module (comprising hardware, software, and/or firmware) capable of querying the one or more LIPC identification modules. Anchor search manager 301 may also be capable of querying database 302 based on one or more LIPCs identified by the one or more LIPC identification modules. Anchor search manager 301 may identify one or more anchors identifying the present location of mobile device 110. Some approaches used in identifying anchors are described above with reference to FIG. 2. In some embodiments, anchor search manager 301 may query database 302 for previously stored prioritization information. For example, more permanent LIPCs (e.g., those embodied in physical manifestations, associated with fixed locations, or provided by a governmental agency, may be preferred over potentially transient ones.) Thus, a barcode embodied in an official signpost may be marked in database 302 as an official LIPC and may be given more priority in the event that multiple LIPCs are available to mobile device 110.

Database 302 is a database capable of storing multiple records relating to multiple anchors. Database 302 may be, for example, a commercial database, a flat file, or a data-structure stored in RAM. In some embodiments, long-term persistence may be a critical requirement. Database 302 may be a cache, subset, or complete replica of database 133. Database 302 may reside in memory 112 on mobile device 110. Database may be capable of enabling the operation (in whole or in part) of the present system and methods during periods of time when mobile device 110 is unable to connect to remote computer 130.

WiFi search 303 is a processing module capable of identifying one or more WiFi base stations within radio range of mobile device 110. Mobile device 110 need not have access rights to send or receive data via the one or more WiFi base stations. This identification may be based, at least in part, on a medium access control (MAC) address, a broadcast base station name, a broadcast public encryption key unique to a base station, or any other LIPC. WiFi search 303 may report to anchor search manager 301 the identities of several available WiFi base stations, or may apply a filtering or prioritization algorithm as described above with reference to anchor search manager 301 and to FIG. 2. While this module has been described as specific to WiFi technologies, one of ordinary skill in the art would understand that this module may be implemented to work with alternative or additional wireless networking or identification (e.g., RFID) technologies.

GSM search 304 is a processing module capable of identifying one or more GSM towers. Mobile device 110 need not have access rights to send or receive data via the one or more GSM towers. This identification may be based, at least in part, on a GSM tower identifier, a broadcast tower name, or any other LIPC. GSM search 304 may report to anchor search manager 301 the identities of several available GSM towers, or may apply a filtering or prioritization algorithm as described above with reference to anchor search manager 301 and to FIG. 2. While this module has been described as specific to GSM, one of ordinary skill in the art would understand that this module may be implemented to work with alternative or additional wireless telecommunication technologies.

Data matrix scan 305 is a processing module capable of reading one or more bar codes visible from mobile device 110. Data matrix scan 305 may process information received from bar code reader 115 or camera 116. An LIPC generated by data matrix scan 305 may be the entire contents of a scanned bar code, a subset of that information, or a representative value derived, at least in part, from the contents of the scanned bar code. Data matrix scan 305 may report to anchor search manager 301 all available LIPCs, or may apply an filtering or prioritization algorithm as described above with reference to anchor search manager 301 and to FIG. 2.

Image recognition module 306 is a processing module capable of identifying a subject of an image captured by camera 116, that identity represented as an LIPC. Image recognition module 306 may identify, for example, structures, natural geographical features, people, signs, or artwork. Image recognition module 306 may report to anchor search manager 301, all available LIPCs, or may apply an filtering or prioritization algorithm as described above with reference to anchor search manager 301 and to FIG. 2

GPS 307 is a processing module capable of determining a coordinate location for mobile device 110 based on signals received from, e.g., multiple global positioning system satellites and/or ground-based GPS transmitters. In some embodiments, GPS 307 may receive signals from other systems, e.g., Galileo or GLONASS.

FIG. 4 illustrates a data structure (e.g., data relationships) representing various data stored and/or processed by an example embodiment of the present disclosure. Data structure 400 includes anchors 401a and 401b, ID 402, name 403, type 404, static data 405, technology data 407, volatile data 406, technology data 408, time stamp 409, user id 410, and chronotope 411.

Data structure 400 illustrates an example organization of data relevant to the present disclosure. Data structure 400 may be implemented in whole or in part by various embodiments of the present disclosure. Data structure 400 may be implemented as one or more objects, data values, and/or database records. Data structure 400 may be stored in database 133, database 302, memory 112, and/or memory 132. Data structure 400 may capture a representation of a location in geometric, symbolic, time-based, and/or semantic terms.

Anchors 401a and 401b each represent a location of a mobile device 110. Anchor 401a represents a physical location based on geographic coordinates (e.g., GPS) or based on an LIPC. In some embodiments, anchor 401a may be associated with a variety of data elements, each of which is described individually as described below. Anchor 401b may be associated with the same or different data elements and is illustrated to show context for chronotope 411.

ID 402 is a unique identifier that may be automatically assigned by mobile device 110 or remote computer 130. ID 402 may or may not be in a format readable by the user.

Name 403 is a plain language or human-readable name that may be displayed to the user, e.g., in a list of possible destination locations. Name 403 may be initially entered by the user or may be retrieved from another source. When a new anchor is generated, e.g., when a user visits a location with mobile device 110 before any other user has done so, mobile application 119 may prompt the user for a human-readable name. This name may be pre-populated with, for example, the WiFi base station ID to be edited or replaced by the user with a more user-friendly name.

Type 404 indicates a technology type, e.g., one that can be used to estimate operational ranges. In some embodiments, type is automatically populated based on the technology used to generate the LIPC associated with anchor 401a.

Static data 405 is a collection of one or more data elements representing static, or relatively static, information about the anchor. Static data may include, for example, technology data 407.

Technology data 407 is a value or set of values capturing the LIPC. For example, technology data 407 may be a GSM tower identifier, a bar code value, a WiFi base station MAC address. Technology data 407 may include a technology-specific range, e.g., a distance from the source of the LIPC to the most distant point where connectivity is possible.

Volatile data 406 is a collection of one or more data elements representing dynamic information relating to anchor 401a. Volatile data 406 may capture information from more than one user, e.g., captured when each user with a mobile device 110 was registered at the location represented by anchor 401a.

Technology data 408 is a value or set of values capturing the LIPC. For example, technology data 407 may be a GSM signal strength, a bar code error value, a WiFi base station RSSI. Technology data 408 differs from technology data 407 in that it is transient. For example, suppose a parking lot is identified by anchor 401a, which is associated with GSM tower ID 44129. While strolling in the vicinity of GSM tower ID 44129 the GSM signal strength will vary based on line-of-site obstructions, distance from the GSM tower, and other factors. Further, suppose that in instant A signal strength was −58 dBm and in instant B signal strength was −71 dBm. Anchor 401a may be associated with technology data 407 set to, e.g., GSM-44129, and may be associated with technology data 408 set to, e.g., −58 dBm. In other embodiments, anchor 401a may be associated with GSM tower 44129 while a different anchor may be associated with −71 dBm.

Time stamp 409 may capture time information along with volatile data 406. Time stamp 409 may, for example, be used to capture the popularity of a location represented by anchor 401a at a given time. User ID 410 may capture user identifying information along with volatile data 406. This may allow system 100 to track a user over time. User ID 410 may, alternatively, be a mobile device identifier.

Chronotope 411 is an association between two anchors, e.g., anchors 401a and 401b. Chronotope 411 may indicate a path taken by a user and may associate various data with that path. For example, chronotope 411 may indicate a mode of transit (e.g., a pedestrian mode, an airplane mode, a bicycle mode, a boat mode, a mass transit mode, and an automobile mode) and may indicate a transit time. In some embodiments, transit time may be calculated by comparing a time stamp 409 associated with anchor 401a with another time stamp 409 associated with anchor 401b. However, in some embodiments, time stamp 409 is only associated with anchor 401a upon arrival, in which case the previous calculation would erroneously include the time the user spent at the location represented by anchor 401a. In certain of these embodiments, chronotope 411 measures the average an average temporal distance between anchor 401a and anchor 401b determined from a plurality of transits recorded in database 133. Chronotope 411 may represent a single transit, wherein an additional chronotope 411 is stored in database 133 each time a user travels from anchor 401a to anchor 401b. Alternatively, chronotope 411 may represent the collection of transits from anchor 401a to anchor 401b.

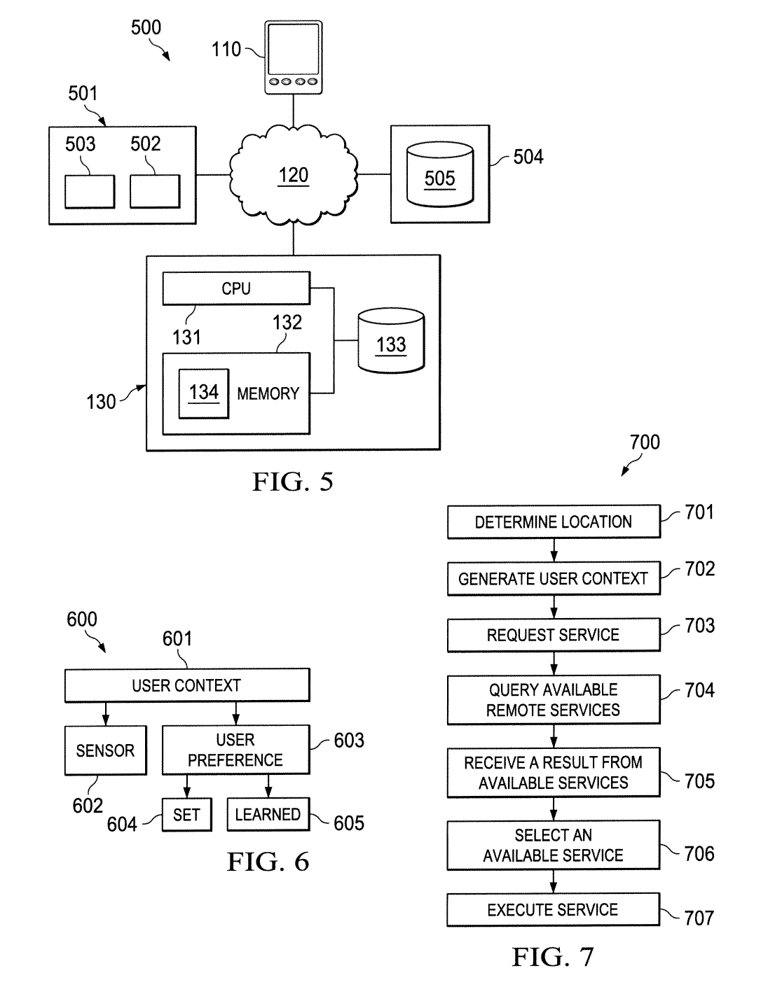

FIG. 5 illustrates a system for providing location-based services, according to an example embodiment of the present disclosure. System 500 includes mobile device 110, network 120, remote computer 130, remote service provider 501, and remote service directory 504. Remote service provider 501 further includes service repository 502 and service content 503.

Remote service provider 501 is a remote computer (e.g., 130) serving a location-based service to mobile device 110. Remote service provider 501 may be physically or logically included within the remote computer 130 or may be separated from remote computer 130. In some embodiments, remote service provider 501 may be independently owned and/or operated from mobile device 110 and/or remote computer 130.

Service repository 502 is a set of one or more available services 140. Service repository 502 may store available services 140 in a compiled and packaged form or may generate them upon request from software components and/or source code. In some embodiments, service repository 502 may be a database of available services indexed by supported platform, system requirements, and user interests. Service repository 502 may also include a revenue module restricting access to customers and/or service providers who agree to pay for the service. In some embodiments, this restricted access may be in the form of a usage-based advertisement wherein a service provider establishes a budget and a set of target contexts for which access to the service will be enabled. This system may operate much like advertisements on a modern search engine.

Service content 503 is a set of content to be consumed or displayed by available service 153. For example, service content 503 may be a database of map segments and geographical boundaries for powering a mapping service. In another example, service content 503 may be a lookup table for converting measurements to clothing sizes. In yet another example, service content 503 may include map data and image processing masks for providing turn by turn directions overlaid on a real-time image. Service content 503 may be provided by the same remote service provider 501 as service repository 502 or may be provided by a different remote service provider 501. In some embodiments, service content 503 may be a database of available content. Similar to service repository 502, service content 503 may also be indexed, for example, by supported platform, system requirements, and user interests. Service content 503 may also include a revenue module restricting access to customers and/or service providers who agree to pay for the content. In some embodiments, this restricted access may be in the form of a usage-based advertisement wherein a service provider establishes a budget and a set of target contexts for which access to the content will be enabled. This system may operate much like advertisements on a modern search engine.

Available service 153 may exist with more than one mobile user interface, e.g., a graphical user interface, or may have a configurable user interface. In some embodiments, remote service provider 501 may transfer available service 153 tailored to the capabilities of mobile device 110 or of the interests of the user. In these embodiments, service repository 502 may respond to a request from mobile computer 110 for available service 153 by retrieving and delivering a specific edition of available service 153 complete with an appropriate user interface. In some embodiments, remote service repository 502 may transfer user interface configuration information, from service content 503, along with available service 153 to mobile device 110. In these embodiments, the user interface configuration information may specify various aspects of the user interface, e.g., fonts, colors, size, and richness of content displayed, to best match the user's interests and the capabilities of mobile device 110.

Remote service directory 504 is service running on a remote computer (e.g., 130) providing a directory of remote service providers 501 to mobile device 110. Remote service directory 504 may be physically or logically included within the remote computer 130 or may be separated from remote computer 130. In some embodiments, remote service directory may be owned and/or operated independently from mobile device 110 and/or remote computer 130. Remote service directory 504 may enable mobile device 110 to locate and retrieve available service 501 from related service repository 502. Further, remote service directory 504 may enable available service 153 to locate and retrieve content from service content 503. Remote service directory 504 may be implemented as, for example, a web search engine, a lightweight directory access protocol (LDAP) server, a remote service 151, or an application store. Remote service directory includes a database 505 of remote services.

FIG. 6 illustrates a data structure (e.g., data relationships) representing various data stored and/or processed by an example embodiment of the present disclosure. Data structure 600 includes user context 601, sensor data 602, and user preference 603, which further includes set values 604 and learned values 605.

Data structure 600 illustrates an example organization of data relevant to the present disclosure. Data structure 600 may be implemented in whole or in part by various embodiments of the present disclosure. Data structure 600 may be implemented as one or more objects, data values, and/or database records. Data structure 600 may be stored in database 133, database 302, memory 112, and/or memory 132.

User context 601 is the root node of the data structure defining the location and preferences of the user. User context 601 may be transmitted by mobile device 110 to remote computer 130 or assembled at remote computer 130 from one or more component parts transmitted by mobile device 110 to remote computer 130.

Sensor data 602 represents the location of mobile device 110. Sensor data 602 may be, for example, an anchor or a coordinate location.

User preference 603 represents the user's preference for an available service 604, which is used in the process of identifying an available service 153. For example, a user may be interested in shopping, dining, exploring, or working and may wish to only see available services compatible with that interest. User preference 603 may be relatively constant, e.g., a user may have an aversion to alcohol products or prefer modern art.

User preference 603 may be a set of one or more component values either set by the user or determined automatically, based at least in part on feedback from the user or a population of users, e.g., in an affinity group with the user. The interests discussed thus far are all content interests. A content interest addresses the topic of the content presented by available service 153. A content interest, as the term is used in the present disclosure, is not a rating filter like, for example, the MPAA film rating (e.g., G, PG, PG-13, etc.) or a search engine filter (“safe search” and “moderate safe search”). Rating filters do address content, but aim to suppress unwanted language, nudity, violence, etc. The examples of user interests discussed in the present disclosure are all content interests. Embodiments of the present disclosure may enable the user to set a rating filter in addition to specifying or determining content interests of the user.

Set value 604 represents preferences specified by the user. In some embodiments, set value 604 is free-form text entered by the user that indicates, for example, an interest of the user. The interest may be ephemeral, e.g., “shopping for music for a party” or “hungry for ice cream.” Alternatively, the interest may be more lasting, e.g., “enjoys impressionist artwork” or “has seafood allergy.” In some embodiments, the language used to define an interest may be structured like a search query, e.g., “NEVER (sea food OR fish OR shellfish)” or “SOMETIMES (fried chicken OR chocolate mousse).” In some embodiments, database 133 may provide a bounded list of available preferences from which a user may select one or more as, for example, applicable or not applicable. In certain embodiments, a user may add a weight to a given preference, for example, by indicating a strong interest in “outdoor adventure” and a lower interest in “book stores.” In some embodiments, a user may alter set value 604 at a later time to account for new or changed interests.

Learned value 605 represents a preference determined by the system. In some embodiments, mobile application 119 takes note of the user's selections and usage patterns and apply suitable algorithms to automatically identify interests. In certain embodiments, mobile application 119 may trigger a survey, for example, when the user selects the available service 153 but subsequently terminates the available service 153 after a short period of use. If, for example, a user selects an interactive restaurant menu service but terminates the menu service before the menu has been completely displayed to the user, mobile application 119 may prompt the user to determine why the user terminated the service. Mobile application 119 may, for example, ask the user to select one or more of the following options: I don't like menu services; I don't like this menu service; I don't like this restaurant; I was interrupted and want to view this later; and I wasn't interested in this restaurant right now, but may be interested another time.

In some embodiments, mobile application 119 and/or remote application 134 may record the frequency and duration of use of one or more available services 140 and apply suitable algorithms to automatically identify interests. For example, if the user accesses educational services whenever available, user application 119 and/or remote application 134 may update learned values 605 to indicate a strong preference for educational services. In another example, if the user accesses entertainment services (e.g., advertisement sponsored games) in the middle of the afternoon, but not in the mornings, user application 119 and/or remote application 134 may update learned values 605 to indicate a preference for such services, but only in that general timeframe.

FIG. 7 illustrates a flowchart of an example method of the present disclosure, according to certain embodiments. Method 700 includes steps of determine location 701, generate user context 702, request service 703, query available remote services 704, receive a result from available services 705, select an available service 706 and execute service 707.

Method 700 may be performed by certain embodiments of the present disclosure. Method 700 may be illustrated as mobile device 110 autonomously identifying a user's present location and finding available services, using remote computer 130, relevant to the user's preferences.

Determine location 701 is a step for generating sensor data 602 and identifying the current location of mobile device 110. In certain embodiments, mobile application 119 identifies a location-identifying physical characteristic and generates an anchor 401a based, at least in part, on the location-identifying physical characteristic. In other embodiments, mobile application 119 generates a coordinate location of mobile device 110 using, for example, GPS module 307.

Generate user context 702 is a step for combining location information, from determine location 701 with user preference 603. In some embodiments, this combination may be performed automatically by the mobile application 119 or remote application 134. In some embodiments, this combination may be performed based on input from the user. The resulting user context forms the basis of a search for available remote service providers 501. In some embodiments, mobile application 119 may generate a unified data structure from sensor data 602 and user preference 603, which can then be transmitted to remote computer 130 for use by remote application 134 in identifying available remote service providers 501. In some embodiments, mobile application may generate sensor data 602 to be transmitted to remote application 134 for combination with user preference 603.

Request service 703 is a step for requesting, e.g., from remote application 134, a remote service provider 501 based at least on context 600. In some embodiments, a unified data structure from mobile device identifies the capabilities and location of mobile device 110, sensor data 602, and user preference 603. This unified data structure may be used when identifying an available remote service provider 501. In some embodiments, this request is made of remote service directory 504.

Query available remote services 704 is a step for determining the availability and/or compatibility of remote service providers 501. In some embodiments, remote application 134 queries a set of known remote service providers 501 as to the availability of each. Remote application 134 generates a query based at least in part on context 600 and mobile device capabilities, jointly with remote service directory 504.

Receive a result from available services 705 is a step for collecting and processing the results received from remote service providers 501. In some embodiments, remote application 134 forwards the each result to mobile device 110. In other embodiments, remote application 134 determines autonomously which, if any, of the available service providers 501 will be utilized and does not communicate with mobile device 110 in making this determination. In these embodiments, remote application 134 may forward a single remote service provider 501 to mobile device 110.

Select an available service 706 is a step for selecting an available remote service provider. The user may be presented, e.g., via UI 118, with one or more available remote service providers 501. In some embodiments, the user may actively accept or reject one or more of the presented remote service providers 501. In some embodiments, the user may save these responses such that if the same remote service provider 501 is presented at subsequent time, the remote service provider 501 will be accepted or rejected automatically, according to the previously saved preference. In some embodiments, more than one remote service provider 501 may be accepted simultaneously. When accepted, the user grants access for remote service provider 501 to mobile device 110.

In some embodiments, mobile application 119 may prompt the user to select an available remote service providers 501 from a list of remote service providers 501, e.g., generated from the query results. Mobile application 119 may then download available service 153 from the selected remote service provider 501, e.g., from remote service repository 502. In other embodiments, remote application 134 automatically selects the remote service provider 501 based at least in part on the user context 600 and downloads available service 153 from the selected remote service provider 501.

In some embodiments, steps determine location 701, generate user context 702, request service 703, query available remote services 704, receive a result from available services 705, and selecting an available service 706 are performed automatically without any user input. For example, the user is about to leave his hotel to explore the city. He inputs, via user input 118, one or more user preferences 604 to indicate that he is sightseeing. Then he places his mobile device 110 in his pocket and starts walking toward the center of the city. As he approaches a coffee shop, his mobile device 110 automatically senses, via WiFi module 303, a WiFi hotspot at the coffee shop and mobile application 119 identifies his location using that information. Mobile application then automatically generates a user context record 601 (including location information represented by sensor 602 and user preference information 603) and sends that record to remote application 134 along with a request for any relevant remote service providers 501. Remote application 134 identifies a sightseeing service—provided by the local chamber of commerce—as relevant and compatible with mobile device 110. Remote service provider 501, e.g., the sightseeing service, performed a compatibility check verifying that mobile device 110 had, for example, an appropriate central processing unit 111, amount of available memory 112, a built-in video camera 116, and a sufficiently fast wireless network connection 120.

Next, the user stops for coffee at the coffee shop. When the user sits down with his cup of coffee, he pulls out his mobile device 110 and sees this prompt on user interface 118: “A service named ‘Sights and Sounds of the City by The Greater Boston Chamber of Commerce’ is available, would you like to access this service?” The user presses the “yes” button. As a result, mobile device 110 requests a download of available service 153 and executes the service. In this example, the user did not provide input between the steps of determine location 701 and selecting an available service 706. This approach may allow a user to quickly and passively identify and access available, location-based services.

Execute service 707 is a step for providing an available service 153 to the user by executing instructions on mobile device 110. In some embodiments, available service 153, running on mobile device 110, may access content (e.g., text, graphics, images, video, and sound) available on mobile device 110 or from remote service provider 501.

For the purposes of this disclosure, the term exemplary means example only. Although the disclosed embodiments are described in detail in the present disclosure, it should be understood that various changes, substitutions and alterations can be made to the embodiments without departing from their spirit and scope.

What is claimed is:

1. A computer implemented method for providing location-based services using a mobile device, the computer implemented method comprising:
automatically determining a location of a mobile device;
generating a user context based at least on a user preference and the automatically determined location of the mobile device, wherein the user preference represents at least a content interest of a user;
requesting from a computer remote from the location of the mobile device an available service relevant to the user context and compatible with a capability of the mobile device; and
executing the available service using the mobile device.

2. The computer implemented method of claim 1 further comprising:
receiving from the remote computer an identification of the available service; and
authorizing, based at least in part on user input, access for the available service to the mobile device.

3. The computer implemented method of claim 1 further comprising:
automatically determining a subsequent location of the mobile device;
generating an updated user context based at least on the user preference and the subsequent location of the mobile device;
automatically determining that the available service is not relevant to the updated user context; and
terminating execution of the available service.

4. The computer implemented method of claim 1, wherein the location of the mobile device is determined at least in part by sensing a single location-identifying physical characteristic and generating a representation of the single location-identifying physical characteristic.

5. The computer implemented method of claim 1 further comprising:
in response to the request for the available service, receiving the available service from the remote computer.

6. The computer implemented method of claim 1 further comprising:
in response to the request for the available service, receiving from the remote computer an identification of the available service existing on the mobile device.

7. The computer implemented method of claim 1, wherein the user provides no input to the mobile device between the steps of automatically determining a location of mobile device and requesting from a computer remote from the location of the mobile device an available service relevant to the user context and compatible with a capability of the mobile device.

8. The computer implemented method of claim 1 further comprising:
receiving an input from the user; and
modifying the user preference based at least on the user input.

9. The computer implemented method of claim 1 further comprising:
receiving a rating of the available service from the user; and
automatically modifying the user preference based at least on the user rating.

10. The computer implemented method of claim 1, wherein the available service submits a search query to an internet search engine, receives a search result, and displays content to the user based at least on the search result.

11. Software embodied in tangible computer-readable media and, when executed by a central processing unit, operable to:
automatically determine a location of a mobile device;
generate a user context based at least on a user preference and the automatically determined location of the mobile device, wherein the user preference represents at least a content interest of a user;
request from a computer remote from the location of the mobile device an available service relevant to the user context and compatible with a capability of the mobile device; and
execute the available service using the mobile device.

12. The software of claim 11 further operable to:
receive from the remote computer an identification of the available service; and
authorize, based at least in part on user input, access for the available service to the mobile device.

13. The software of claim 11 further operable to:
automatically determine a subsequent location of the mobile device;
generate an updated user context based at least on the user preference and the subsequent location of the mobile device;
automatically determine that the available service is not relevant to the updated user context; and
terminate execution of the available service.

14. The software of claim 11, wherein the location of the mobile device is determined at least in part by sensing a single location-identifying physical characteristic and generating a representation of the single location-identifying physical characteristic.

15. The software of claim 11 further operable to:
in response to the request for the available service, receive the available service from the remote computer.

16. The software of claim 11, wherein the software requires no user input to between the steps of automatically determining a location of mobile device and requesting from a computer remote from the location of the mobile device an available service relevant to the user context and compatible with a capability of the mobile device.

17. The software of claim 11 further operable to:
in response to the request for the available service, receive from the remote computer an identification of the available service existing on the mobile device.

18. The software of claim 11 further operable to:
automatically determine the location of the mobile device; and
request from the computer remote from the location of the mobile device the available service relevant to the user context and compatible with the capability of the mobile device without receiving an intervening input to the mobile device from the user.

19. A computing system comprising:
a central processing unit;
a memory coupled to the central processing unit; and
a mobile application enabled to:
automatically determine a location of a mobile device;
generate a user context based at least on a user preference and the automatically determined location of the mobile device, wherein the user preference represents at least a content interest of a user;
request from a computer remote from the location of the mobile device an available service relevant to the user context and compatible with a capability of the mobile device; and
execute the available service using the mobile device.

20. The computing system of claim 19, wherein the mobile application is further enabled to:
automatically determine a subsequent location of the mobile device;
generate an updated user context based at least on the user preference and the subsequent location of the mobile device;
automatically determine that the available service is not relevant to the updated user context; and
terminate execution of the available service.

21. The computing system of claim 19, wherein the location of the mobile device is determined at least in part by sensing a single location-identifying physical characteristic and generating a representation of the single location-identifying physical characteristic.
